(19) United States
(12) Patent Application Publication
(10) Pub. No.: US 2003/0182583 A1
(43) Pub. Date: Sep. 25, 2003

(54) Electronic document classification and monitoring

(75) Inventor: Anthony Jay Turco, Balmain Cove (AU)

Correspondence Address: WOOD, PHILLIPS, KATZ, CLARK & MORTIMER, 500 W. MADISON STREET, SUITE 3800, CHICAGO, IL, 60661, US

(73) Assignee: Panareef Pty. Ltd.

(21) Appl. No.: 10/396,617

(22) Filed: Mar. 25, 2003

(30) Foreign Application Priority Data
Mar. 25, 2002 (AU) PS 1297

(51) Int. Cl. H04L 9/00

(52) U.S. Cl. 713/201

(57) ABSTRACT

This invention concerns electronic document classification and monitoring. Electronic documents are files that are created or modified using a computer. In general the invention involves three components: A policy server to hold a classification policy for documents. A document handling software application operable to create and modify documents. And a document handling software application enhancer automatically operable under the control of the policy server to require a user to apply a classification to a document after creating or modifying it using the document handling software application.

### TECHNICAL FIELD

This invention concerns electronic document classification and monitoring. Electronic documents are files that are created or modified using a computer.

### BACKGROUND ART

The increasing frequency of computer-borne virus outbreaks, malicious internet worms and the threat of “denial-of-service” attacks has led to the creation of computer security systems with a single focus on perimeter defense.

However, perimeter-oriented security measures do not address the key business issues of protection of intellectual property and confidential information. Many businesses acknowledge financial loss as a result of security breach, and reports estimate that a high proportion of security breaches happen within the enterprise.

An example of the invention is later described which makes use of so called ‘web bugs’. Web bugs are typically represented as HTML IMG tags and they may be constructed to be as small as 1-by-1 pixel which can render them invisible. They have been used in Web pages and email messages to monitor who is reading them.

It is also possible to insert a ‘web bug request’ into a file in any application or program that has the ability to link to an image file located on a remote Web server. Every time the file is opened in the application the ‘web bug request’ requests the web bug image from the remote server. Since this image may be a 1-by-1 blank pixel it is not seen. At the same time the remote server is able to collect information such as:

The URL of the file containing the ‘web bug request’.

The IP address of the computer where the file was opened.

The time the file was opened.

This information can be used to monitor where and when the file is opened. The web bug request is also able to access the user's cookies.

Examples of software applications with image linking ability include Microsoft's Office Suite™ and Sun Microsystems' Star Office™.

### SUMMARY OF THE INVENTION

In a first aspect the invention is a computer system for classifying and monitoring electronic documents, the system comprises:

A policy server to hold a classification policy for documents, and optionally a scheme for the placement of ‘web bug requests’ in documents of each classification.

A document handling software application operable to create and modify documents.

A document handling software application enhancer automatically operable under the control of the policy server to require a user to apply a classification to a document after creating or modifying it using the document handling software application. In particular a document will not be allowed to be saved before a classification is selected by the user and applied.

After it has been classified, the document handling software application may operate to populate that document with a series of named ‘web bug requests’ according to the scheme defined for the applied classification.

In this case a tracking and reporting web server holding an image represented as an HTML IMG tag, and automatically operable to return the image, or a message related to the image, whenever it receives web bug request from a document containing at least one of the named ‘web bug requests’, and to acquire the name of the web bug request, the address of the computer holding the document and the time the document was opened.

In a second aspect, the invention is a document handling software application enhancer that is automatically operable to require a user to apply a classification to a document after creating or modifying it using the document handling software application, at the time it is saved. And after it has been classified, the enhancer may operate to populate that document with a series of named ‘web bug requests’ according to a scheme defined for the applied classification.

In a third aspect, the invention is an electronic document, or part of a document, that has been classified according to a predetermined scheme, and is also be populated with a series of named ‘web bug requests’ placed throughout the document according to the scheme defined for the applied classification.

The system is a non-intrusive application that automatically applies organizational data labelling and information classification policies whenever documents are saved. It centrally stores organizational policy and ensures users classify and label information regardless of their location, and maintains a central repository of organizational information and provides web-based access to business reporting, eliminating the need for costly manual auditing.

The classification policy may indicate if the information is to be labelled with any specific markings and wether or not the information will create a usage based audit trail. Usage based auditing is accomplished by creating a “creation record” for the information at the point of save. At no time will there ever be information that is saved on magnetic media, under a policy that requires auditing, without the tracking enabled (this includes temp files) Information tagged under a policy that requires auditing will create (whenever possible) a “read record” that is sent to a central repository on the internet or within a company to be correlated with other pertinent information.

In this way the system extends beyond ordinary security systems by correlating where a document is viewed with the classification of the document and the document originator. The organization may unobtrusively track in real time, the usage of information across the corporate infrastructure to determine if information abuse is occurring. It may also track usage across logical boundaries such as departments, networks, privileged groups or companies.

This allows the automatic marking and securing of information based upon its classification to ensure distribution is to intended groups only.

The system works from within the environment currently employed to create information. For instance the document may comprise information produced using any of the following document handling software applicaions: Microsoft Office including Word, Excel and Powerpoint, Sun's Star Office, Adobe's Acrobat and many other current and future applications. It does not require any special additional software on the part of the recipient to ensure the auditing and labelling is intact.

Auditing usage of the information across platforms becomes possible in any application in which electronic documents are created or modified. For instance Microsoft Word on Microsoft Windows is capable of being audited when it is opened on Sun's StarOffice running on Linux. Additionally, when information is created in Word or Excel, then published to Adobe Acrobat, the Audit trail is maintained regardless of the platform used to open the information.

It enables an organization or company to raise security awareness through the mass labelling of information via policy at the point of creation, ensure usage of information was executed by those departments, individuals or companies that were intended to receive the information and ensure the protection of trade secrets and confidential information in a non-intrusive fashion.

The document handling software application enhancer may be any type of program that is loaded into the system to operate with the document handling software under the control of the policy server. It will typically be written in C⁺⁺, although it may be written Visual Basic or a combination of the two. The enhancer may be provided in the form of a ‘plug in’ say to Microsoft Word™.

In operation, when an employee creates or modifies a document using the document handling software application and seeks to save that document they will be presented with a dialogue box requesting them to select a classification. They will be unable to save the document until a classification is selected. Once a classification has been selected the document is saved and the policy server applies the requirements of that classification to the document. Each ‘web bug request’ is given a unique name, according to a naming convention. For instance, each employer may have a unique name and require an organization-wide unique number to be given to each document created. Version numbers may be added each time the document is modified. The naming convention may require the time, date and user's identity to be added into the document name.

Once the document has been classified, subsequent opening of the document will cause the web bug request to attempt to link to the tracking and reporting web server and request the web bug image to be downloaded. Whenever the document is opened in an application that has the ability to link an image file located on a remote web server, the request should be successful, and should take place without the user being aware of it. Both the request and download are very small and are transmitted very quickly. Since the downloaded image is small and transparent it cannot be seen. At the same time the tracking and reporting web server captures the name of the web bug request and the identity of the computer which opened the document. The tracking and reporting server will also log the time, and be able to unpack any other information included in the name of the request.

In the event that a part of a classified document is copied to another document, provided at least one web bug request is present in the copied part, it will also be copied into the new document and will continue to transmit requests to the tracking and reporting web server.

The tracking and reporting web server will be able to create a history of the usage of any classified document, and documents that receive parts of it. This history can be used to provide regular reports, and it can also be audited.

Numerous reports enable an organization or company to query the system in an effort to discover integrity or disclosure breaches. The reports form an easy way to validate the trust and integrity of an organization and raise awareness across the spectrum of security and information handling.

### BRIEF DESCRIPTION OF THE DRAWINGS

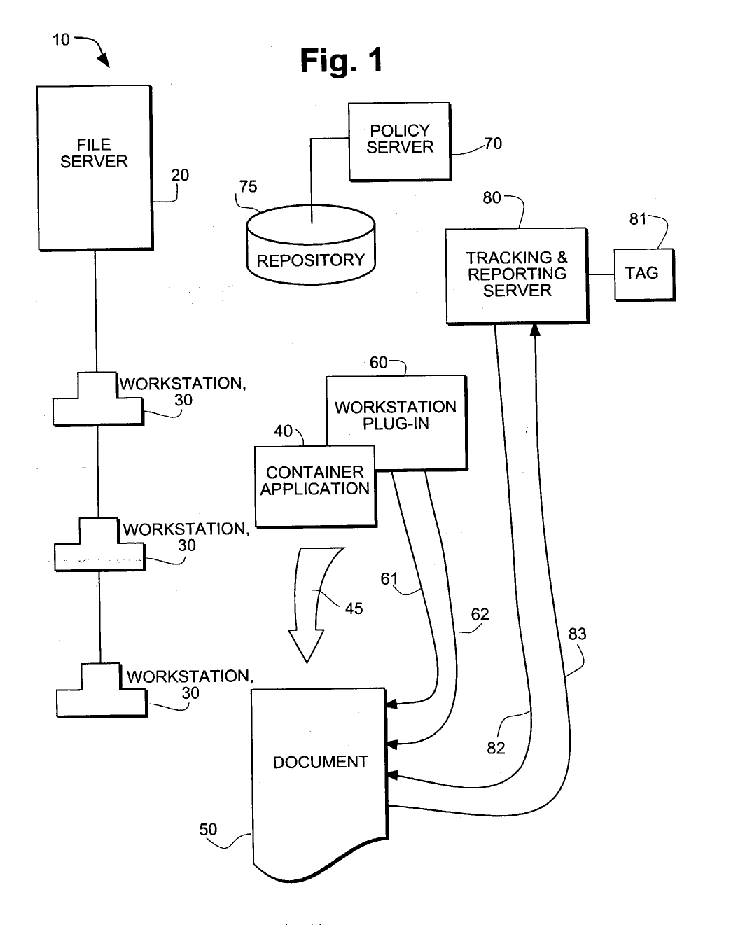

An example of the invention will now be described with reference to the accompanying FIG. 1 which is a block diagram of a computer system.

### BEST MODES OF THE INVENTION

A typical computer network 10 comprises a file server 20 and a series of networked workstations 30. The configuration of the workstations 30 is not important, but they each generally have installed a document handling software application, or ‘container application’, 40 operable to create and modify 45 documents 50, an example is Microsoft Word™.

There are three fundamental components of the system enhancements that are typically added to an existing computer network to perform the invention:

1. A document handling software application enhancer, or workstation plug-in 60.

2. A policy server 70.

3. A tracking and reporting server 80.

The workstation plug-in 60 is installed on all participating desktops 30. Its purpose is to automate the labelling process of any document in accordance with the organization's policies.

A workstation plug-in 60 is a COM object or software module that communicates with Office 2000 (or later). It usually performs a specific task or adds certain functionality to the software. The plug-in 60 uses HTTP protocols.

The workstation plug-in consists of:

1. the “registered” Office plug-in

2. primary functions used by pre32dw.dll, and

3. the encrypted local database of policy and document information.

All three are duplicated for each user installing the plug-in. The Office plug in is “branded” with the knowledge of which organization it belongs to and which web site it reports back to. It is a “.dll” file and cannot be copied across organizations.

Distribution is a two-part process. The plug-in firstly needs to be distributed in an installer/CD. Secondly, it needs to be copied to the server for automatic distribution if it changes.

When the workstation plug-in is running on a client machine, it replaces itself from the copy on the server.

The document handling software application enhancer, or ‘plug in’ 60 is associated with the container application 40. The container application provides the environment for the plug-in to run. The plug-in cannot run on its own. When associated with the container application, the plug in is automatically operable under the control of the policy server 70 to require a user to apply a classification 61 to a document 50 after creating or modifying it using the container application 40. After a document 50 has been classified, the plug in 60 populates it 62 with a series of named ‘web bug requests’ according to the scheme defined for the applied classification.

The plug-in 60 auto-updates every seven days, or in any situation where the integrity of the plug-in comes into question. Updates will be retrieved from the database server 70, as defined from within the plug-in 60.

The policy server 70 is used to host a special information repository 75 to hold a classification policy for documents and a scheme for the placement of ‘web bug requests’ in documents of each classification. It has the Microsoft SQL server installed on it configured for “integrated security”. The information repository is a series of Microsoft SQL tables. It is defined to enable the workstation plug-in 60 to centrally store information required for adequate and proper reporting on organizational information usage.

In greater detail, the repository 75 contains configuration, policy, document and installation details. A policy table contains all the security classifications used by the organisation. An install table keeps track of PCs that have the plug-in installed. And a document table keeps track of documents and their classifications.

An example of a policy will now be given:

This policy outlines the extent to which data classification standards should be followed. It also provides guidelines for classifying the data and sets forth the controls to safeguard operations against security breaches while at the same time defining individual responsibilities.

A Data classification standard applies to all data created and maintained, regardless of the medium on which it resides or form it takes. This data can be contained on paper, fiche, electronic tape, cartridge, disk or CD-Rom and may present itself as text, graphic, video or voice.

The Data classification standard applies to all authorised users.

For each kind of data, there is a custodian who is responsible for the day-to-day oversight of data. For instance there may be a custodian for a project or task, for a department, and for producing system data such as backup tape. Data custodians should know and understand the data for which they are responsible. They should evaluate and ensure that the data has been appropriately classified based on confidentiality; criticality and sensitivity of data. The responsibility to set initial data classification falls upon the originator of the data. It is the responsibility of the data custodian to ensure compliance with the “Data Classification Standard.”

There are four (4) levels of data classification:

Public—data that can be accessed by the public but can be updated/deleted by authorized people only. The data may be made generally available without specific approval.

Internal Use—information that is intended for use within the organisation. Its unauthorized disclosure could seriously and adversely impact the organisation and/or its customers. A non-disclosure Agreement protecting this data should be instituted.

Restricted—the most sensitive business information that is intended strictly for use within the organisation. Its loss, corruption or unauthorized disclosure would tend to impair the organisation's reputation to the public, or result in a business, financial or legal loss. Its' access control is task oriented in meaning but not limited to an application program source code or system configuration.

Strictly Confidential—data that requires special precautions to assure the integrity of the information, by protecting it from unauthorized modification or deletion. It is information that requires a higher than normal assurance of accuracy and completeness. This information will normally be protected by the use of passwords, or encryption keys.

Aggregates of data should be classified based upon the highest level of information contained within. For example, when data of mixed classification exist in the same file, report or memorandum, the classification of the file is levied at the level of the highest single report contained within.

Procedures regarding data security and classification shall require that:

The circulation of the Open to Public data is not restricted.

Internal Use data should be restricted to staff.

Access to Restricted and Strictly Confidential data should be based on a need to know or job function. For Restricted data, the data custodian should assign appropriate access right to related users.

Strictly Confidential data must be assigned to users with specific operation or senior management ONLY.Strictly Confidential data must be kept in locked environment. It must not be shared except the custodian's designee.

For Internal Use, Restricted or Strictly Confidential document, it should state: Copyright reservation, non-disclosure Agreement, access to data is given to authorized users. This access should not be shared, transferred or delegated.

Authorized users act in a manner which will ensure that the data they are allowed to access is protected from unauthorized access, unauthorized use, invalid changes, destruction, or improper dissemination.

A secure tracking and reporting server 80 is added to the network. This server should be placed where it is visible to both the public internet and the private intranet—in other words in a demilitarized zone (DMZ).

In a typical DMZ configuration, a computer (or host in network terms) receives requests from users within the private network for access to web sites or other companies accessible on the public network. The DMZ host then initiates sessions for these requests on the public network. However, the DMZ host is not able to initiate a session back into the private network. It can only forward packets that have already been requested.

Users of the public network outside the company can access only the DMZ host. The DMZ may typically also have the company's web pages so these could be served to the outside world. However, the DMZ provides access to no other company data. In the event that an outside user penetrated the DMZ host's security, the web pages might be corrupted but no other company information would be exposed.

HTTP requests must be able to reach the tracking and reporting server 80 from both the internal network and the public network. This means the tracking and reporting server will need to be “hardened”. For more information on “hardening” servers, see: www.microsoft.com/security.

The tracking and reporting server 80 is configured to track and audit the usage of documents. It has installed on it: a Microsoft SQL client; Microsoft IIS 5.0; enabled Microsoft active server pages, and a valid SSL certificate.

The tracking and reporting server 80 holds an image represented as an HTML IMG tag 81, and is automatically operable to return 82 the image 81 whenever it receives a web bug request 83 from a classified document 50. Alternatively, the image itself may not be returned, and instead a message related to the image, such as an error message may be returned.

Such a request is generated whenever a classified document 50, or part of a classified document containing at least one of the named ‘web bug requests’, is opened using a document handling software application having the ability to link an image file located on a remote web server. When this happens, the tracking and reporting web server 80 acquires the name of the web bug request, the address of the computer where the document was opened and the time the document was opened.

The purpose of the tracking and reporting server is to collect any information usage as it occurs. Information usage is defined as the opening, closing, altering or creating of any information on a machine where the workstation plug-in is installed and enabled.

The tracking and reporting server 80 needs to be able to send Microsoft SQL queries to and from the policy server 70. As networks communicate to the tracking and reporting server 80, it stores the information in the policy server 80.

Because they communicate only with the tracking and reporting server 80, workstation plug-ins 60 can go on any affected or nominated workstation, inside or outside the corporate network.

When a user tries to save a document that hasn't been classified, they see a pop-up message from the tracking and reporting server 80 as follows:

“It is policy that all documents be classified in accordance with our document classification and labelling policy. The policy can be viewed at [URL]”.

The plug-in will display a drop-down control for the selection of an organisation specific classification from the policy.

After classification 17, the plug-in will cache the classification with the document using the following custom properties:

Unique ID

Doc Name

Classification

The current policy for the given classification will dictate how the document is to be formatted (watermarks and emblazons) and how many web-bug requests are to be installed. The plug-in will also distribute web-bugs throughout the document according to the policy.

The format for the bugs is as follows:

{INCLUDEPICTURE http://(Configuration.WebBug/program.asp?details\*MERGEFORMAT\d}

While this is the tag for the actual embedded picture the image size needs to be separately set to 1-by-1 pixel. The text of the document can be accessed by either their paragraph or their section. Ie. Word.Paragraphs.Range.Text or Word.Sections.Range.Text.

Web bug requests can be inserted between or within paragraphs depending on the classification requirements of the document. Where classification is to be applied at the paragraph rather than the document level, the web bug requests should be placed within rather than between paragraphs.

When a classified document 50 is opened to be viewed or modified, the web bug requests in the document will be logged in a WebServer log in tracking and reporting web server 80. Analysis of these logs will reveal when and where the document was opened and counting the bugs requested will indicate whether the document is intact or maybe copy-and-pasted.

It is also useful to provide some facility for identifying which actual user has initiated each request, regardless of the OriginatingIP and OriginatingHost. Cookies are items of information exchanged between an HTTP server and user agent. They may be maintained for an individual session, but can persist between sessions for most user agents. Cookies can be used to provide limited user identification. Users are tracked, where possible, using cookies. When a given user first connects to the tracking and reporting web server 20, they are assigned a user identification cookie, which can be used to identify them when they make subsequent requests.

A hash function can be used to confirm to the web tracking and reporting server 80, that the Plug-in 60 is same one that was installed on a pc and that it has not been modified since installation. If not, then an update process will be triggered to bring them back into step.

The system will generally be installed at an organisation, such as an employer. Each such organization will be allocated an organization ID. The organization IDs are checked whenever a new document is registered, or a modified document is re-registered. If the organizationlD of the Install record for the unique ID does not match that for the desired Policy record, the registration or re-registration will be rejected and an exception logged.

Reporting

Everyday Reports

Usage reports show information about classified documents that are created, modified, and saved. Viewing reports show information about document views that occur on machines that aren't equipped with the client software. The Viewing Controlled reports describe views that occur on machines that have clients installed.

Special Reports

Some of the more complex reporting facilities are able to detect registered users who are connected to IP Subnets not associated with their security community. This functionality can be found by navigating to the Documents menu, then choosing In Dual Community under Usage.

Features in Depth

| Report | Description of Data Accessible |
|---|---|
| Organisation | Organisation details. Read Only. |
| → Details | |
| Organisation | Classification policies configured within the organisation. |
| → Policies | Use the hyperlinks to view information about communities |
| | that are configured to use a particular classification. |
| Organisation | Information about communities configured within the |
| → | organisation. Communities are composed of IP Subnets, and |
| Communities | selected client installations (individually identified machines). |
| | By default all client installations/users are members of the |
| | “(undefined)” community. Individual users/client installations |
| | can be assigned to specific communities by a Classify |
| | administrator. To view a list of installations assigned in this |
| | way, click a hyperlink in the Installations column. Members |
| | of the “(undefined)” community are dynamically assigned to |
| | other communities on a per—session basis according to the |
| | IP Subnet to which they are attached. To view IP Subnet |
| | community allocations, click a hyperlink in the IP Subnets column. |
| Organisation | Whenever a client install occurs, an event will appear in this |
| → Installations | report. The Version Number column indicates which version |
| | of the client was present at installation. The Classify Server |
| | automatically pushes out the most recent DLL to clients |
| | when they intermittently (every 7 days) update their local policy stores. |
| Organisation | Detailed information, including network addresses and |
| → IP Subnets | masks, about IP Subnets defined within the organisation. |
| Trust Network | This report provides information about company information |
| → Community | flow policies. Each policy governs the bi-directional flow of |
| Trust Policies | information between two communities. Every row in the table |
| | describes a single policy. Rows are readable both left to right and right to left. |
| | In all cases, the “trust” is on the part of the organisation, i.e. |
| | “Trusted sender” means that the organisation trusts the |
| | community to send information, “Not trusted” means that the |
| | organisation does not trust the community to send or receive |
| | information, etc. |
| | An example 1: |
| | Community Name |
| | Trusted Zone Name |
| | Classification Identifier |
| | Trust Zone Name |
| | Community Name |
| | Marketing |
| | Trusted Recipient |
| | Commercial in Confidence |
| | Trusted Sender |
| | Development Team |
| | From left to right, this policy reads: Marketing is a Trusted |
| | Recipient of Commercial-in-Confidence documents from |
| | Development Team. |
| | From right to left, this policy reads: Development Team is a |
| | Trusted Sender of Commercial-in-Confidence documents to |
| | Marketing. |
| | In English: Organisation policy is that Marketing can receive |
| | Commercial-in-Confidence documents from the |
| | Development Team (i.e. They are trusted to handle such |
| | information). Implicitly, however, Marketing may not send |
| | Commercial-in-Confidence documents to the Development |
| | Team, and, the Development Team may not receive (view) |
| | Commercial-in-Confidence documents from Marketing (i.e. It |
| | is a security breach for Marketing to leak such information to |
| | the Development Team, and the Development Team should |
| | not trust such information if received). |
| | An example 2: |
| | Community Name |
| | Trusted Zone Name |
| | Classification Identifier |
| | Trust Zone Name |
| | Community Name |
| | Marketing |
| | Fully Trusted |
| | Commericial in Confidence |
| | Trusted Sender |
| | Development Team |
| | From left to right, this policy reads: Marketing is a Trusted |
| | Recipient AND Trusted Sender of Commercial-in-Confidence |
| | documents from/to Development Team. |
| | From right to left, this policy reads: Development Team is a |
| | Trusted Sender of Commercial-in-Confidence documents to |
| | Marketing. |
| | In English: Organisation policy is that Marketing can receive |
| | and send Commercial-in-Confidence documents from/to the |
| | Development Team (i.e. They are never at fault for |
| | communicating Commercial-in-Confidence information with |
| | the Development Team). Implicitly, however, the |
| | Development Team may not receive/view Commercial-in- |
| | Confidence documents sent from Marketing (i.e. The |
| | organisation does not trust them to receive such information |
| | and to do so would be an integrity breach—the Development |
| | Team should not trust any such information). |
| | It is possible to have seemingly contradictory policies |
| | configured (such as in the second example above). Policies |
| | might be configured in this way during an investigation into a |
| | particular community. |
| Clients → | A user is anyone who views a classified document, without a |
| Users | client installed. Users are tracked across multiple IP |
| | addresses by way of a cookie (cookie codes are visible in |
| | this report). The IP address at which a user was first noticed |
| | is also visible on this report—for a complete list of user IP |
| | addresses, select a hyperlink in the List Doc Views By User |
| | column. If Reverse DNS is active, IP addresses are resolved |
| | to domain names in the Remote Host columns. |
| Clients → User | This report shows information about the browsers (agents) |
| Agents | used by document users. Often corporate information will be |
| | stored in this identifier. |
| Documents → | Document usage is tracked by way of the Classify client |
| Usage | software. Information available in this report is only available |
| | for those sites/machines/users who have installed the client. |
| | The List of Documents visible here shows all documents |
| | registered with the system and their genealogy. If a |
| | registered document is ever resaved, a new Document ID is |
| | (re)registered with the system. In this way different versions |
| | of a document are tracked. Select a hyperlink in the |
| | Genealogy column to view a document's ancestors and |
| | progeny. |
| | Several options are available on the side menu for this |
| | report. Each shows document usage by different categories |
| | of client. In each of the following cases, ‘usage’ refers to the |
| | saving (registering) or re-saving (reregistering) of a classified |
| | document. |
| | In non-Community shows documents registered/reregistered |
| | by clients that are not placed within a trust community. If |
| | anything appears in this report, it should be immediately be |
| | considered a security breach. |
| | By unknown IPSubnet shows document usage by clients |
| | located at network addresses not recognised by the |
| | organisation's configuration. This might occur if, for instance, |
| | an employee uses their laptop in an Airport departure lounge |
| | and communications occur via the free internet provided in |
| | the lounge. |
| | By unknown Installation shows document registrations from |
| | clients that have not correctly notified the server of an |
| | installation. No documents should ever appear in this report, |
| | as the server will not recognise requests from these clients. |
| | In dual community is an interesting report, and describes |
| | document usage by an installation/client that has been |
| | specifically placed in a community, but who is |
| | communicating from an IP Subnet known to belong to a |
| | different community. |
| | Both By untrusted Recipient and By untrusted Sender |
| | provide reports on document usage that contravenes system |
| | policy. By untrusted Recipient shows documents used by |
| | communities that are not marked as “Trusted Recipients” for |
| | documents of that level of classification (this is a disclosure |
| | breach). By untrusted Sender shows documents used by |
| | communities that are not marked as “Trusted Senders” for |
| | documents of that level of classification. |
| Documents → | The viewing report shows information about uncontrolled |
| Viewing | document views (views of a document where no Classify |
| | client is installed). The side menu gives several sorting |
| | options. |
| | By Address, and By Host sort the data by the address from |
| | which a view notification was received. |
| | Of unknown Documents describes views of documents that |
| | are not registered within the system. |
| | By unknown IP Subnet shows document reads that occurred |
| | at IP Addresses not within any of the defined IP Subnets. |
| | A “non-apparent” user is a machine that would not accept a |
| | tracking cookie. If a user does not accept cookies, then |
| | multiple reads by the same machine from different IP |
| | Addresses cannot be correlated and merged to form a single |
| | user's viewing history. By non-apparent User shows reads |
| | from such machines. |
| | Since views in this report are uncontrolled views, the only |
| | way to place them within communities in the system is by the |
| | IP Subnet from which the view notification originates. So in |
| | this report, Of non-Community has similar functionality to By |
| | unknown IP Subnet (but with fewer filtering options). |
| | The By untrusted Recipient and By untrusted Sender options |
| | work in a similar fashion to those available in the Usage |
| | report, however, in this case the only means by which a user |
| | can be allocated to a community is by the IP Subnet from |
| | which their view notification originates (since no client is |
| | installed on the machine), therefore these reports might be |
| | sparsely populated. |
| Documents → | The Viewing Controlled reports are similar to those in the |
| Viewing | Viewing reports. However, since view notifications shown |
| Controlled | here are controlled (a client is installed on the viewing |
| | machine), more information can be given in the reports, and |
| | views can be better allocated into communities. |
| Troubleshooting | This report contains internal system state information. |
| → | Exceptions may appear in here from time to time—this does |
| Exceptions | not indicate erroneous operation. |

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A computer system for classifying and monitoring electronic documents, comprising:
a policy server to hold a classification policy for documents;
a document handling software application operable to create and modify documents;
a document handling software application enhancer automatically operable under the control of the policy server to require a user to apply a classification to a document after creating or modifying it using the document handling software application.

2. A computer system according to claim 1, where a document will not be allowed to be saved before a classification is selected by the user and applied.

3. A computer system according to claim 1, where the policy server also holds a scheme for the placement of ‘web bug requests’ in documents of each classification.

4. A computer system according to claim 3, where after a document has been classified, it is populated with a series of named ‘web bug requests’ according to the scheme defined for the applied classification.

5. A computer system according to claim 4, where the system further comprises a tracking and reporting server to hold an image represented as an HTML IMG tag, and automatically operable to return the image, or a message related to the image, whenever it receives web bug request from a document containing at least one of the named ‘web bug requests’, and to acquire the name of the web bug request, the address of the computer holding the document and the time the document was opened.

6. A computer system according to claim 4, where each ‘web bug request’ is given a unique name.

7. A computer system according to any preceding claim, where the document handling software application enhancer is in the form of a ‘plug in’.

8. A computer system according to claim 5, where the tracking and reporting web server creates a history of the usage of a classified document.

9. A computer system according to claim 5, where the tracking and reporting web server creates a history of the usage of a document that receives part of a classified document.

10. A computer system according to claim 8 or 9, where the history is used to provide reports.

11. A computer system according to claim 8 or 9, where the history is used to detect integrity or disclosure breaches.

12. A computer system according to claim 5, where the tracking and reporting server is located in a DMZ.

13. A computer system according to claim 12, where the tracking and reporting server is able to receive HTTP requests.

14. A document handling software application enhancer that is automatically operable to require a user to apply a classification to a document after creating or modifying it using the document handling software application, at the time it is saved.

15. A document handling software application enhancer according to claim 14, operable to populate a classified document with a series of named ‘web bug requests’ according to a scheme defined for the applied classification.

16. A document handling software application enhancer according to claim 15, where each ‘web bug request’ is given a unique name.

17. A document handling software application enhancer according to any one of claims 14, 15 or 16, where the document handling software application enhancer is in the form of a ‘plug in’.

18. An electronic document, or part of a document, that has been classified according to a predetermined scheme, and is also populated with a series of ‘web bug requests’ placed throughout the document according to the scheme defined for the applied classification.
